(19) United States
(12) Patent Application Publication
(10) Pub. No.: US 2009/0010012 A1
(43) Pub. Date: Jan. 8, 2009

(54) METHODS AND SYSTEMS OF ATTACHING A DEOCRATIVE LIGHT MOUNTING DEVICE

(76) Inventor: M. Brent George, Slaton, TX (US)

Correspondence Address: CONLEY ROSE, P.C.;David A. Rose, P. O. BOX 3267, HOUSTON, TX, 77253-3267, US

(21) Appl. No.: 11/772,629

(22) Filed: Jul. 2, 2007

(51) Int. Cl. F21V 21/096; F21V 21/30

(52) U.S. Cl. 362/398; 362/382; 362/427

(57) ABSTRACT

A method and system of attaching a decorative light mounting structure. At least some of the illustrative embodiments are decorative light mounting devices comprising a bulb support portion having an aperture and an affixation portion coupled to the bulb support portion. The affixation portion is configured to magnetically affix the decorative light mounting structure to substantially only an upper surface of a metallic roofing material.

### BACKGROUND

Several types of devices exist to assist home owners and business owners in attaching decorative lights to the exterior of their buildings, typically seasonally, such as during the Christmas holidays. Some of these devices assist the home owner or business owner in attaching the decorative lighting to hang from rain gutters. Other devices may attach by sliding between the roofing material (e.g., composition shingles) and the roof decking material. Others of these devices attach by clamping to the roofing material.

However, a growing trend in the construction industry is the use of sheet metal roofing material instead of composition shingles. In most cases, the sheet metal roofing material extends beyond the fascia material by several inches, thus making the support brackets configured to slide between the roofing material and the roof decking material unusable. In other cases, the sheet metal extends a very short distance beyond the fascia material, thus making a clamp-type device unusable.

### SUMMARY

The problems noted above are addressed, at least in part, by a decorative light mounting structure that magnetically affixes to the sheet metal roofing material. At least some of the illustrative embodiments are decorative light mounting devices comprising a bulb support portion having an aperture and an affixation portion coupled to the bulb support portion. The affixation portion is configured to magnetically affix the decorative light mounting structure to substantially only an upper surface of a metallic roofing material.

### BRIEF DESCRIPTION OF THE DRAWINGS

For a more detailed description of various embodiments, reference will now be made to the accompanying drawings, wherein:

FIG. 1 illustrates use of decorative light mounting structures in accordance with various embodiments;

FIG. 2 illustrates a decorative light mounting structure in greater detail;

FIG. 3 illustrates a partial cross-sectional view of a decorative light mounting structure (taken along 3-3 of FIG. 1);

FIG. 4 illustrates alternative embodiments of a decorative light mounting structure;

FIG. 5 is a flow diagram illustrating methods in accordance with at least some embodiments;

FIG. 6 illustrates a decorative light mounting structure in accordance with alternative embodiments; and

FIG. 7 illustrates use of the alternative decorative light mounting structures.

### NOTATION AND NOMENCLATURE

Certain terms are used throughout the following description and claims to refer to particular system components. This document does not intend to distinguish between components that differ in name but not function.

In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct connection. Thus, if a first device couples to a second device, that connection may be through a direct connection, or through an indirect connection via other devices and connections.

### DETAILED DESCRIPTION

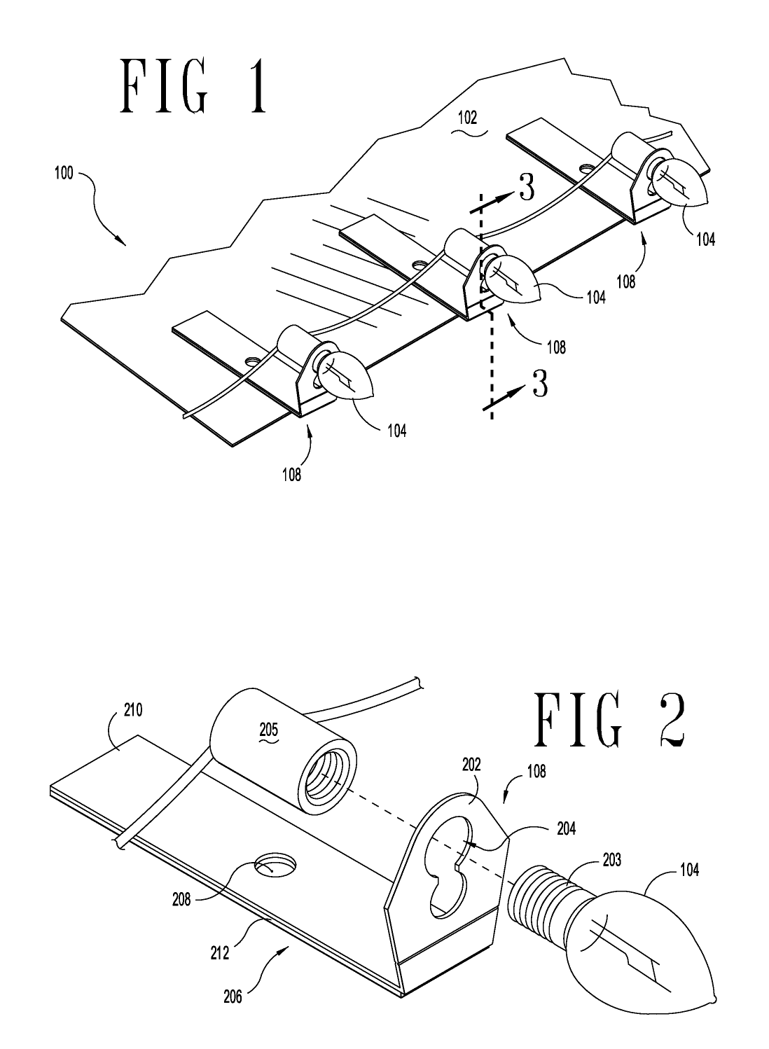

FIG. 1 illustrates a decorative light mounting system 100 in accordance with various embodiments. In particular, each decorative bulb 104 is held in place on a sheet metal roof 102 by way of a decorative light mounting structure 108. The decorative light mounting structure 108 holds the bulb 104 in a consistent orientation across the installation, and also enables the consistent spacing of the bulbs 104 for an aesthetically pleasing configuration.

FIG. 2 shows in greater detail the decorative light mounting structure 108 in accordance with various embodiments. In particular, FIG. 2 illustrates that the decorative light support device 108 comprises a bulb support portion 202 having a bulb aperture 204 therein. As illustrated in FIG. 2, the bulb base 203 extends through the bulb aperture 204 and threadingly couples to the bulb socket 205. As illustrated in FIG. 2, the bulb aperture 204 may be configured to have two or more different diameters such that bulb 104 and socket 205 assemblies of different sizes may be used with the decorative light mounting structure 108. The bulb support portion 202 may be made from materials such as metal, polypropylene, and polystyrene.

Still referring to FIG. 2, the decorative light mounting structure 108 further comprises an affixation portion 206. The affixation portion 206 defines a plane that, in at least some embodiments, is substantially perpendicular to the plane defined by the bulb support portion 202. The affixation portion 206 has a thickness, measured perpendicular to a plane defined by such, of about 0.125 inches.

FIG. 2 further illustrates that in accordance with at least some embodiments the affixation portion 206 comprises a coupling layer 210 and a magnetic strip 212 coupled to the coupling layer 210 by way of an adhesive. The coupling layer 210 may be made from materials such as metal, polypropylene, and polystyrene. The magnetic strip 212 is configured to at least partially affix the decorative light mounting structure 108 to the sheet metal roof 102. The magnetic strip 212 may be magnetic strip material available from Flexmag Industries of Marietta Ohio. Alternative embodiments may use a magnetic strip that has a smaller area than the entire affixation portion 206. In accordance with at least some embodiments, the length of the affixation portion 206, as measured from the plane defined by the bulb support portion 202, is from about 2 inches to about 5 inches; however, longer or shorter affixation portions 206 may be equivalently used.

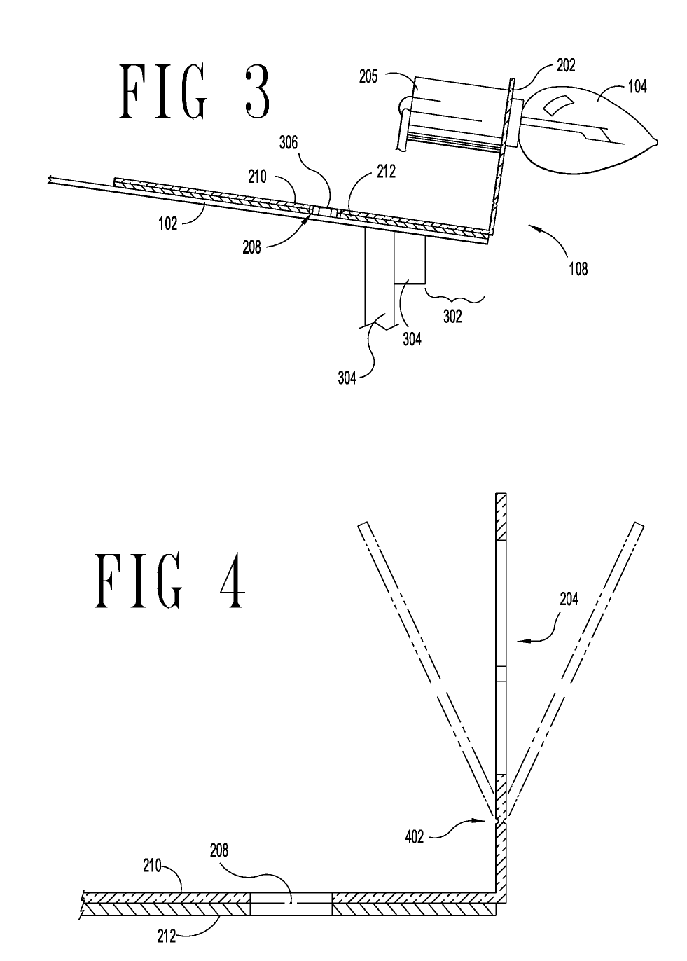

FIG. 3 is a partial cross-sectional view (taken substantially along 3-3 of FIG. 1) in accordance with at least some embodiments. In particular, FIG. 3 illustrates the decorative light mounting structure 108 coupled to a metal roof 102. In the illustrative embodiments of FIG. 3, the metal roof 102 overhangs 302 the fascia material 304. The bulb 104 coupled to the socket 205 through the upper portion of the bulb aperture 204. The magnetic strip 212 is shown to be substantially affixed to the sheet metal roof 102, thus ensuring affixation of the decorative light mounting structure 108 to the sheet metal roof 102. Some embodiments utilize a fastener aperture 208 to allow the use of the decorative light mounting structure 108 in situations where a fastener for the roof material is located where a user desires to place a decorative light mounting structure 108, and to prevent motion of the decorative light mounting structure 108 in the plane defined by the affixation portion 206. In the embodiments illustrated in FIG. 3, the decorative light mounting structure is shown to be “straddling” a fastener 306 being a screw head coupled to the sheet metal roof 102 by way of the fastener aperture 208. The fastener 306 is substantially encompassed by the fastener aperture 208, thereby preventing motion along the plane defined by the affixation portion 206.

FIG. 4 is a cross-sectional view in accordance with at least some embodiments. In some embodiments, a flexible pivot joint 402 may be located in the lower bulb support portion 202. The flexible pivot joint 402 enables the bulb support portion 202 to flex so as to reduce the possibility of the disconnection of the decorative light mounting structure 108 during high winds. In particular, by flexing (either toward or away the affixation portion 206) the bulb support portion 202 reduces the surface area against which wind may push. Higher winds may result in more flexing at the pivot joint 402, while low winds result in less flexing at the pivot joint 402. The lowered surface area thus lowers the torque applied by the wind to the overall device, lowering the possibility of the decorative light mounting structure 108 becoming dislodged by high wind.

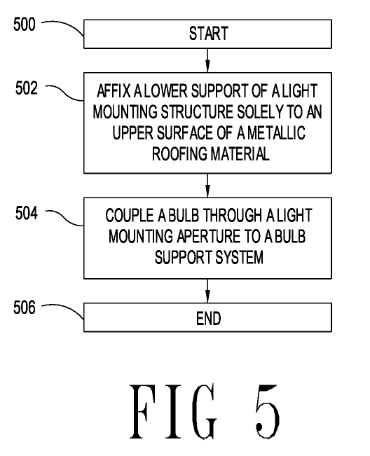

FIG. 5 illustrates a method of mounting the decorative light system. In particular, the method starts (block 500) and proceeds to affixing an affixation portion 206 of the decorative light mounting structure 108 solely to an upper surface of a sheet metal roof 102 (block 502) by way of a magnetic strip 212. In some embodiments, the decorative light mounting structure 108 may be further secured by allowing a fastener aperture 208 to “straddle” a fastener 306 coupled to the sheet metal roof 102. Thereafter, the decorative light system is coupled to the decorative light mounting structure 108 (block 504); and the method ends (block 506). Coupling may comprise inserting the bulb base 203 through the bulb aperture 204 and threadingly coupling the bulb base 203 to the socket 205.

FIG. 6 illustrates a decorative light mounting structure 308 in accordance with alternative embodiments. In particular, FIG. 6 illustrates that the decorative light support device 308 comprises a bulb support portion 302 and an affixation portion 206. The bulb support portion 308 is similar to the bulb support portion 208 in that is comprises a bulb aperture 204, but differs in that the bulb support portion 308 also comprises fingers 3 10. In particular, in some embodiments fingers 310 comprise two upward pointing fingers 312, and one downward pointing finger 314. However, fewer fingers 312, and fingers pointing in alternative directions, may be equivalently used. The fingers 312 enable the decorative light mounting structure 308 to accommodate wiring for other types of decorative lighting, such as lights that mimic the appearance of icicles.

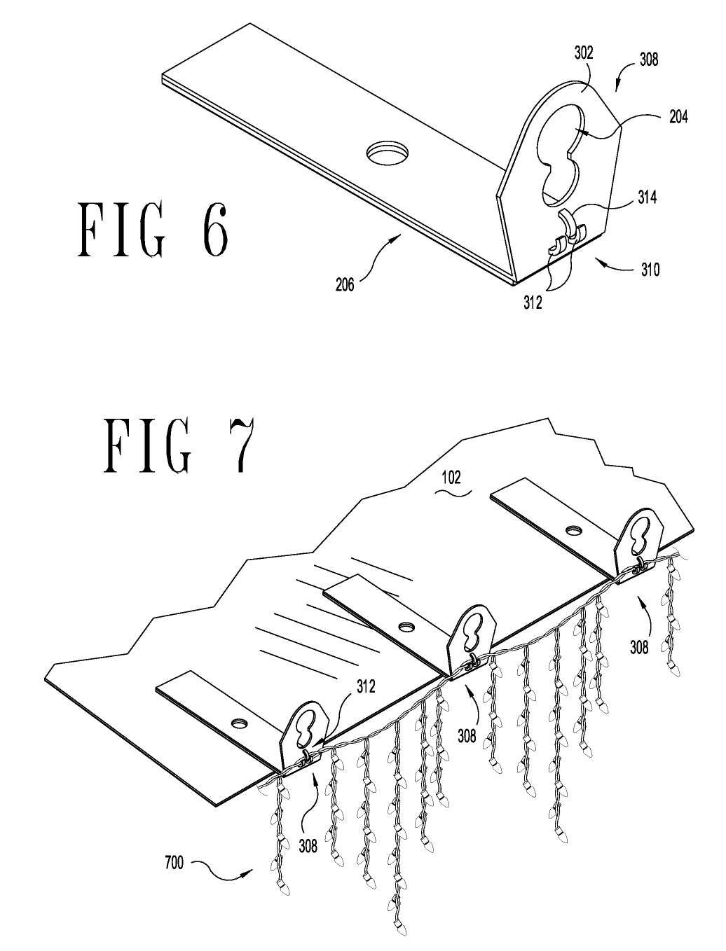

FIG. 7 illustrates a plurality of the decorative light mounting structures 308 coupled to a roof material 102. A strand of decorative lights 700 is suspending from the roof material 102 by way of the decorative light mounting structures 308. In particular, at least a portion of the wires for the decorative lights 700 are engaged with the fingers 312 such that the decorative lights 700 are suspended. Thus, the decorative light mounting structures 308 not only support a bulb installed through the apertures 204 (not shown in FIG. 7), but also enable the home owner or business owner to install suspended-type decorative lights 700.

Various embodiments discussed to this point may be constructed of varying materials. In most situations it is envisioned that the decorative light mounting structure 108 will be constructed of polypropylene, polystyrene, and/or any now known or after developed plastic material. In alternative embodiments, the decorative light mounting structure 108 may be made from metal or from a magnetic material being substantially as resilient as polypropylene or polystyrene.

The above discussion is meant to be illustrative of the principles and various embodiments of the present invention. Numerous variations and modifications will become apparent to those skilled in the art once the above disclosure is fully appreciated. For example, the affixation portion itself may be magnetized, eliminating the need for a separate magnetic strip. It is intended that the following claims be interpreted to embrace all such variations and modifications.

1. A decorative light mounting structure comprising:
a bulb support portion having an aperture;
an affixation portion coupled to the bulb support portion, wherein the affixation portion is configured to magnetically affix the decorative light mounting structure to substantially only an upper surface of a metallic roofing material; and
an aperture configured to encompass a fastener previously coupled to the metallic roofing material.

2. The decorative light mounting according to claim 1 where the affixation portion further comprises:
a coupling layer; and
a magnetic strip coupled to the coupling layer.

3. (canceled)

4. The decorative light mounting structure according to claim 1 wherein the aperture configured to encompass is further configured to encompass a fastener being a screw head coupled to the roofing material.

5. The decorative light mounting structure according to claim 1 wherein the aperture configured to encompass is further configured to limit motion along a plane defined by the affixation portion.

6. The decorative light mounting structure according to claim 2 wherein the coupling layer has a thickness, measured perpendicular to a plane defined by the coupling layer, of approximately 0.125 inches.

7. The decorative light mounting structure according to claim 2 wherein the coupling layer substantially covers a surface of the magnetic strip.

8. The decorative light mounting structure according to claim 2 wherein the coupling layer couples to the magnetic strip by way of an adhesive.

9. The decorative light mounting structure according to claim 2 wherein the bulb support portion and the coupling layer are made from at least one material selected from the group consisting of: metal; polypropylene; and polystyrene.

10. The decorative light mounting structure according to claim 1 wherein the bulb support portion further comprises a plurality of fingers configured suspend decorative lights.

11. The decorative light mounting structure according to claim 1 wherein the aperture of the bulb support portion further comprises a light mounting aperture having one or more diameters.

12. A system comprising:
a means for supporting a bulb and socket assembly; and
a means for affixing a decorative light mounting structure to a roofing material, the means for affixing coupled to the means for supporting;
the means for affixing further comprises a means for encompassing a fastener previously coupled to the roofing material.

13. The system as defined in claim 12 wherein the means for affixing further comprises a means for magnetically coupling.

14. The system as defined in claim 12 further comprising a means for suspending lights from the means for supporting.

15. A method comprising
affixing a lower support of a light mounting structure solely to an upper surface of a metallic roofing material by encompassing a fastener previously coupled to the metallic roofing material; and
coupling a bulb through a light mounting aperture to a bulb support portion.

16. The method according to claim 15 wherein affixing further comprises coupling the decorative light mounting structure to the metallic roofing material by way of a magnetic strip.

17. The method according to claim 15 further comprising suspending lights from fingers of the light mounting structure.

18. The method as defined in claim 15 wherein encompassing a fastener further comprises placing a fastener aperture over a screw head previously coupled to the metallic roofing material.

19. The method as defined in claim 15 wherein coupling further comprises:
placing a bulb base through the light mounting aperture; and
threadingly coupling the bulb base to a bulb socket.

20. The decorative light mounting structure comprising as defined in claim 1 wherein the bulb support portion further comprises a joint configured to enable flexing of the bulb support portion in high winds.
